(19) United States
(12) Patent Application Publication
(10) Pub. No.: US 2019/0238010 A1
(43) Pub. Date: Aug. 1, 2019

(54) STATOR OF ROTARY ELECTRIC MACHINE

(71) Applicant: HONDA MOTOR CO., LTD., Tokyo (JP)

(72) Inventor: Tomotaka IKI, Saitama (JP)

(73) Assignee: HONDA MOTOR CO., LTD., Tokyo (JP)

(21) Appl. No.: 16/260,408

(22) Filed: Jan. 29, 2019

(30) Foreign Application Priority Data
Jan. 30, 2018 (JP) 2018-014089

(51) Int. Cl. H02K 1/20; H02K 1/16; H02K 3/12; H02K 9/19

(52) U.S. Cl. CPC H02K 1/20; H02K 9/19; H02K 3/12; H02K 1/165

(57) ABSTRACT

A stator for a rotary electric machine includes: a stator core in which a plurality of slots are formed; and a coil including a plurality of coil segments inserted into each of the plurality of slots. At least a first coil segment and a second coil segment are arranged in each of the plurality of slots so as to be overlapped in a radial direction. A heat transportation sheet is arranged on overlapping surfaces of the first coil segment and the second coil segment. The heat transportation sheet includes at least refrigerant receiving parts which project from one axial end surfaces of the stator core and a heat exchange part which is positioned in the slot and exchanges heat with the first coil segment and the second coil segment at the overlapping surfaces.

### CROSS-REFERENCE TO RELATED APPLICATION

This application is based on and claims priority under 35 USC 119 from Japanese Patent Application No. 2018-014089 filed on Jan. 30, 2018, the contents of which are incorporated herein by reference.

### TECHNICAL FIELD

The present disclosure relates to a stator for a rotary electric machine which is mountable on an electric vehicle, a hybrid vehicle, or the like.

### BACKGROUND

A stator for a rotary electric machine includes a stator core and a coil attached to the stator core. Recently, a so-called segmented conductor type rotary electric machine is known in which a coil loop is formed as the coil by joining a plurality of coil segments (see Patent Literature 1 (Japanese Patent Application Laid-Open Publication No. 2006-211779)).

In order to increase the output of such a rotary electric machine, it is necessary to cool the coil which is a heat generating source. Conventionally, a method of cooling the rotary electric machine by supplying a refrigerant such as water or oil to the outside of the stator core or a coil end is used as the cooling method of the rotary electric machine in many cases.

In addition, a method is also proposed in which a plate-shaped heat pipe is arranged in a coil bundle layer inserted into a slot, and an inner section of the slot is cooled through transporting heat in the heat pipe (see Patent Literature 2 (Japanese Patent Application Laid-Open Publication No. H10-248211)).

However, efficiency of cooling the inner section of the slot is not excellent in the method of performing cooling by supplying the refrigerant to the outside of the stator core or the coil end.

In the cooling method described in Patent Literature 2, the heat pipe is inserted in the coil bundle layer. Thus, there are problems that the manufacturing process of the rotary electric machine becomes complicated and the manufacturing cost is increased. In addition, when considering a size which allows the heat transportation function of the heat pipe to be realized, the occupancy rate of the coil in the slot is reduced remarkably.

The present disclosure provides a stator for a rotary electric machine which is capable of efficiently cooling an inner section of a slot.

### SUMMARY

A stator for a rotary electric machine related to the present disclosure includes: a stator core in which a plurality of slots are formed; and a coil including a plurality of coil segments inserted into each of the plurality of slots. At least a first coil segment and a second coil segment are arranged in each of the plurality of slots so as to be overlapped in a radial direction. A heat transportation sheet is arranged on overlapping surfaces of the first coil segment and the second coil segment. The heat transportation sheet includes at least refrigerant receiving parts which project from one axial end surfaces of the stator core and a heat exchange part which is positioned in the slot and exchanges heat with the first coil segment and the second coil segment at the overlapping surfaces.

According to the present disclosure, the heat transportation sheet is arranged on the overlapping surfaces of the first coil segment and the second coil segment, and thus the refrigerant supplied to the coil end is guided to the heat exchange part through the refrigerant receiving parts. Further, the inner section of the slot can be efficiently cooled by drawing heat from the first coil segment and the second coil segment at the heat exchange part.

### BRIEF DESCRIPTION OF DRAWINGS

Exemplary embodiments of the present disclosure will be described in detail based on the following figures, wherein:

FIG. 1 is a perspective view of a stator for a rotary electric machine of a first embodiment;

FIG. 2 is a perspective view of a first coil segment in the stator illustrated in FIG. 1;

FIG. 3 is a perspective view of a second coil segment in the stator illustrated in FIG. 1;

FIG. 4 is a developed view partially illustrating the stator illustrated in FIG. 1 when viewed from the outside in a radial direction of a stator core;

FIG. 5 is a perspective view illustrating a vicinity of a joining portion of the first coil segment and the second coil segment illustrated in FIG. 4 when viewed from an end surface side of the stator core;

FIG. 6 is a sectional view illustrating a slot portion in the stator for the rotary electric machine illustrated in FIG. 1;

FIG. 7A is a developed view illustrating a state where an elongated rectangular heat transportation sheet is arranged in the stator core of the stator illustrated in FIG. 1 when viewed from the inside of the radial direction of the stator core:

FIG. 7B is a developed view illustrating a state where the heat transportation sheet having a structure, in which refrigerant receiving parts are connected to one another, is arranged in the stator core of the stator illustrated in FIG. 1 when viewed from the inside in the radial direction of the stator core;

FIG. 8 is a sectional view illustrating a slot portion in a stator for a rotary electric machine of a second embodiment;

FIG. 9 is a sectional view illustrating a slot portion in a stator for a rotary electric machine of a third embodiment; and

FIG. 10 is a sectional view illustrating a slot portion in a stator for a rotary electric machine in a fourth embodiment.

### DETAILED DESCRIPTION

Hereinafter, embodiments of the present disclosure will be described with reference to the drawings.

### First Embodiment

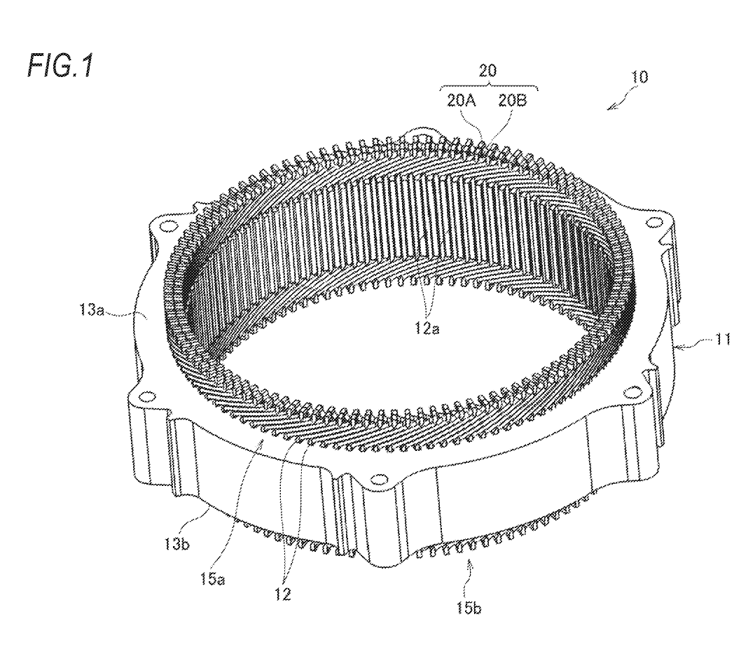

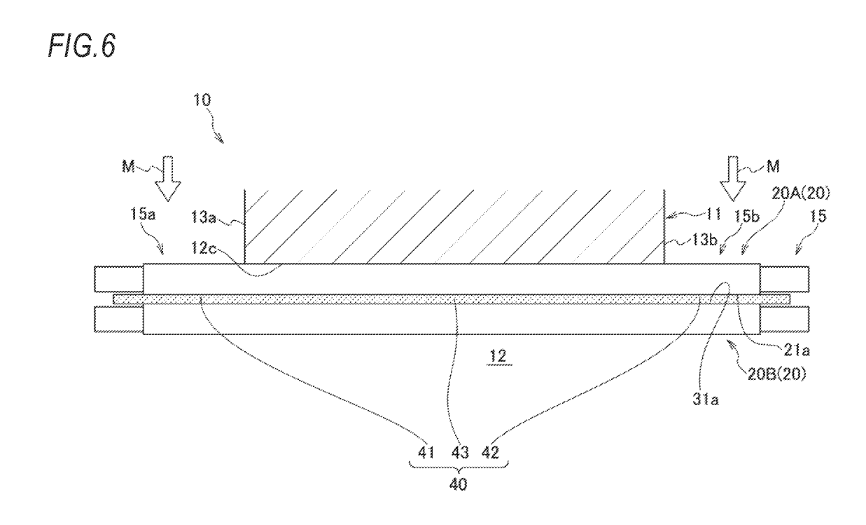

As illustrated in FIGS. 1 and 5, a stator for a rotary electric machine 10 of a first embodiment includes a stator core 11 and a coil 15 attached to the stator core.

The stator core 11 is, for example, an annular member which is formed by stacking a plurality of annular electromagnetic steel sheets. In the stator core 11, a plurality of teeth 16 are provided at regular intervals in a circumferential direction, and a slot 12 is formed between the adjacent teeth 16.

The slot 12 is a groove which extends from an end surface 13a on one axial side of the stator core 11 to an end surface 13b on the other axial side of the stator core 11 and includes an opening part 12a in the inner circumferential surface of the stator core 11. In the slot 12, inner wall surfaces 12b facing each other in the circumferential direction extend toward the radial inside in an approximately linear shape from a bottom surface 12c on the radial outside to the opening part 12a. Therefore, a plurality of opening parts 12a are provided at regular intervals along the circumferential direction in the inner circumferential surface of the stator core 11.

The coil 15 includes a plurality of coil segments. The coil segment is inserted from the opening part 12a of the slot 12 formed in the stator core 11, and coil ends 15a and 15b project to the axial outside from both end surfaces 13a and 13b of the stator core 11.

The plurality of coil segments 20 includes a plurality of first coil segments 20A and a plurality of second coil segments 20B. The first coil segment 20A is inserted to the outer diameter side of the slot 12 of the stator core 11. The second coil segment 20B is inserted to the inner diameter side of the slot 12 of the stator core 11.

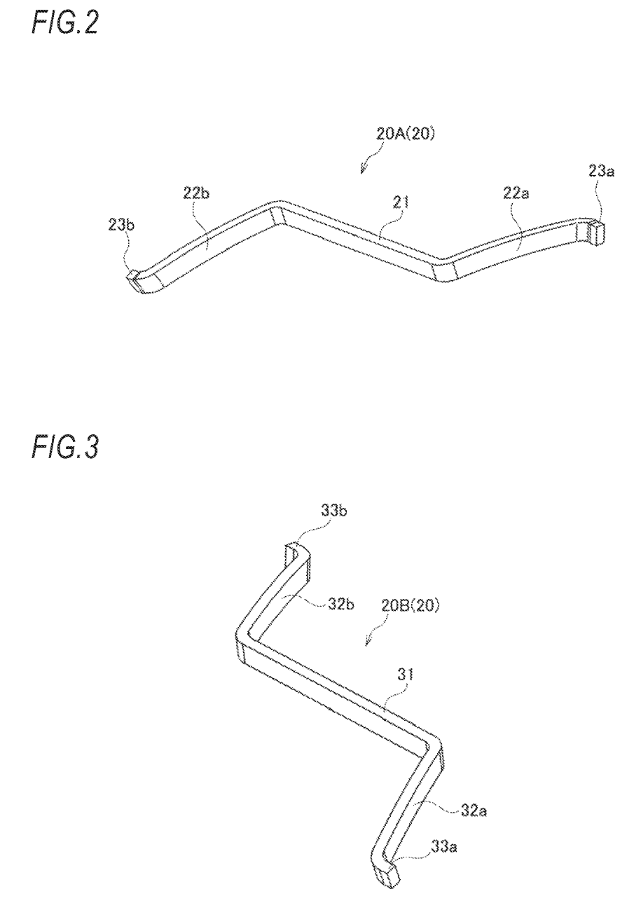

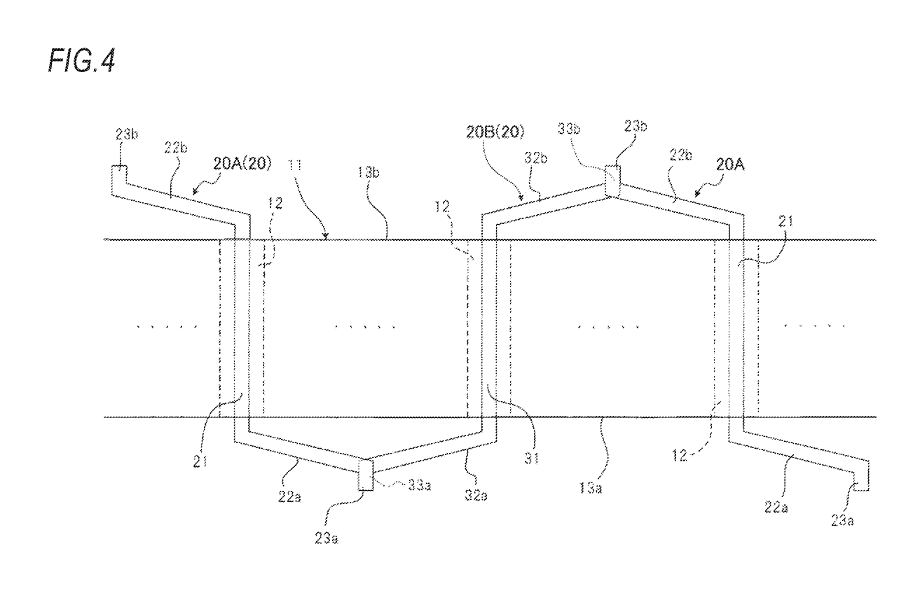

As illustrated in FIGS. 2 and 3, for example, the first coil segment 20A and the second coil segment 20B are formed by performing wire processing on a copper wire and are approximately crank-shaped members having an approximately rectangular cross section. The first coil segment 20A is a so-called magnet wire and includes a conductor and an insulating film covering the conductor.

The first coil segment 20A includes a linear insertion part 21 inserted into the slot 12, a first projection part 22a which projects from one end of the insertion part 21 to the outside in the axial direction of the stator core 11 further from the end surface 13a of the stator core 11, and a second projection part 22b which projects from the other end of the insertion part 21 to the outside in the axial direction further from the end surface 13b of the stator core 11.

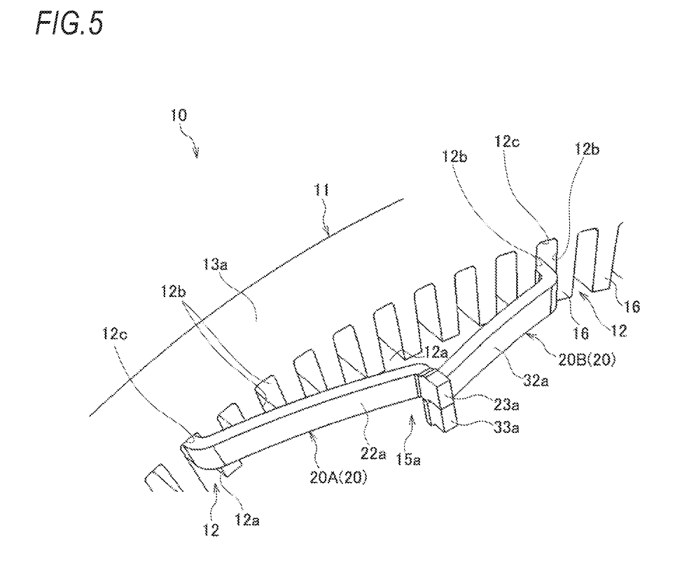

The first projection part 22a extends along the circumferential direction of the stator core 11 toward the right direction in FIG. 4. The second projection part 22b extends along the circumferential direction of the stator core 11 toward the direction (the left direction in FIG. 4) opposite to the first projection part 22a.

The second coil segment 20B includes an insertion part 31 inserted into the slot 12, a third projection part 32a which projects to the outside in the axial direction of the stator core 11 further from the end surface 13a of the stator core 11, and a fourth projection part 32b which projects to the outside in the axial direction further from the end surface 13b of the stator core 11.

The third projection part 32a extends along the circumferential direction of the stator core 11 toward the left direction in FIG. 4. The fourth projection part 32b extends along the circumferential direction of the stator core 11 toward the direction (the right direction in FIG. 4) opposite to the third projection part 32a.

As illustrated in FIGS. 4 and 5, an end part 23a of the first coil segment 20A is joined with an end part 33a of the second coil segment 20B inserted into another slot 12 which is at a position separated from the slot 12 (hereinafter, referred to as an insertion slot) where the first coil segment 20A is inserted in one direction of the circumferential direction of the stator core 11 (specifically, a position which is moved clockwise from the insertion slot by nine slots when viewed from the end surface 13a side). For example, the joining is performed by laser welding in which an insulating film covering the conductor is melted to electrically connect the conductors to one another. Incidentally, in FIG. 4, as for the coil 15, only a pair of the first coil segment 20A and the second coil segment 20B connected electrically are extracted and illustrated for facilitating understanding.

An end part 23b of the first coil segment 20A is joined with an end part 33b of the second coil segment 20B inserted into still another slot 12 which is at a position separated from the insertion slot in the other direction of the circumferential direction of the stator core 11 (specifically, a position which is moved counterclockwise from the insertion slot by nine slots when viewed from the end surface 13a side).

In this way, a coil loop is formed by repeating the joining of the end part 23a of the first coil segment 20A and the end part 33a of the second coil segment 20B and the joining of the end part 23b of the first coil segment 20A and the end part 33b of the second coil segment 20B.

The coil 15 includes a plurality of coil loops, and the plurality of coil loops are selectively connected to configure a power line of plural phases (such as a U-phase, a V-phase, and a W-phase).

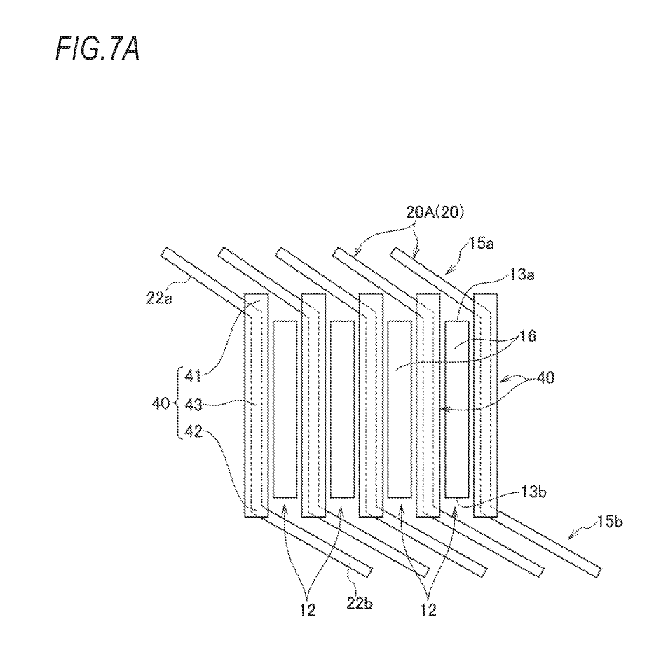

As illustrated in FIG. 6, a heat transportation sheet 40 is arranged between overlapping surfaces 21a and 31a of the first coil segment 20A and the second coil segment 20B.

The first coil segment 20A, the second coil segment 20B, and the heat transportation sheet 40 are inserted into the slot 12 from the opening part 12a (see FIG. 5) of the slot 12 which is open to the inside of the stator core 11. Specifically, the heat transportation sheet 40 is inserted into the slot 12 after the first coil segment 20A is inserted into the slot 12. Thereafter, the second coil segment 20B is inserted into the slot 12. Accordingly, the heat transportation sheet 40 is arranged in the slot 12 being interposed between the both coil segments 20A and 20B. In this way, the first coil segment 20A, the second coil segment 20B, and the heat transportation sheet 40 are inserted to the slot 12 from the opening part 12a of the slot 12 which is open to the inside of the stator core 11. Thus, the assemblability is improved.

The heat transportation sheet 40 includes refrigerant receiving parts 41 and 42 which project from both end surfaces 13a and 13b in the axial direction (the direction of the arrow A of FIG. 6) of the stator core 11 and a heat exchange part 43 which is positioned in the slot 12. The refrigerant receiving parts 41 and 42 absorb a refrigerant M supplied to the coil ends 15a and 15b and guide the refrigerant to the heat exchange part 43. The heat exchange part 43 exchanges the heat with the first coil segment 20A and the second coil segment 20B at the overlapping surfaces 21a and 31a.

The heat transportation sheet 40 is a mesh-shaped sheet, and provides the refrigerant M a movable passage therein by a capillary action. Incidentally, the example of the mesh shape includes a woven fabric in which meshes are regularly formed, a nonwoven fabric in which meshes are irregularly formed, and a material in which fiber bundles are superposed. In addition, the material of the heat transportation sheet may be natural fibers or chemical fibers. Cotton is preferable as the natural fiber, and rayon, cupra, nylon, polyester, acrylic, polyurethane, and the like are preferable as the chemical fiber.

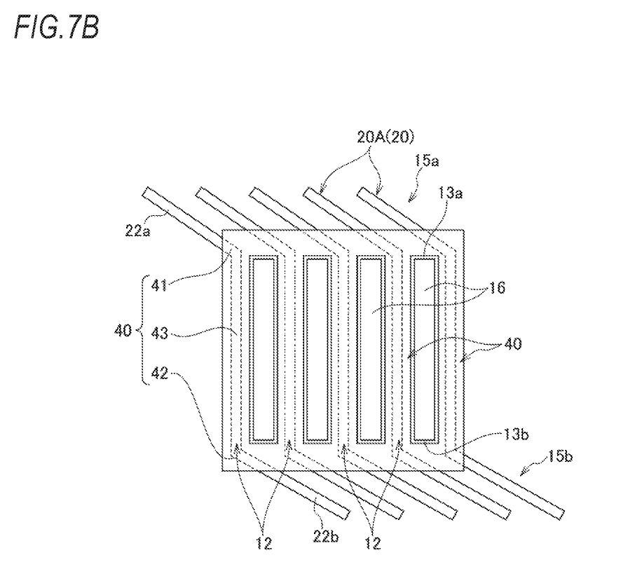

The heat transportation sheet 40 illustrated in FIG. 7A is formed in an elongated rectangular strip shape in each of the slots 12. Accordingly, the inner section of the slot 12 can be cooled using the heat transportation sheet 40 having an extremely simple structure. On the other hand, the heat transportation sheet 40 illustrated in FIG. 7B has a structure in which the heat transportation sheets 40 arranged in the plurality of adjacent slots 12 are connected at the refrigerant receiving parts 41 and 42 projecting from both axial end surfaces 13a and 13b of the stator core 11. Therefore, the number of the heat transportation sheets 40 can be reduced, whereby it is possible to reduce the man-hours for arranging the heat transportation sheet 40.

In this way, the heat transportation sheet 40 is arranged between the overlapping surfaces 21a and 31a of the first coil segment 20A and the second coil segment 20B, and thus the refrigerant M supplied to the coil ends 15a and 15b is guided to the heat exchange part 43 through the refrigerant receiving parts 41 and 42. Further, the refrigerant M draws heat from the first coil segment 20A and the second coil segment 20B at the heat exchange part 43, thereby cooling the inner section of the slot 12 which has been difficult to cool so far. In addition, the refrigerant M is evaporated depending on a heat quantity, and thus the inner section of the slot 12 can be cooled more effectively using the vaporization heat.

### Second Embodiment

Next, a stator for a rotary electric machine 10 of a second embodiment of the present disclosure will be described. In the first embodiment, only two coil segments 20 are inserted into the slot 12 of the stator core 11. However, the number of the coil segments 20 can be more than three.

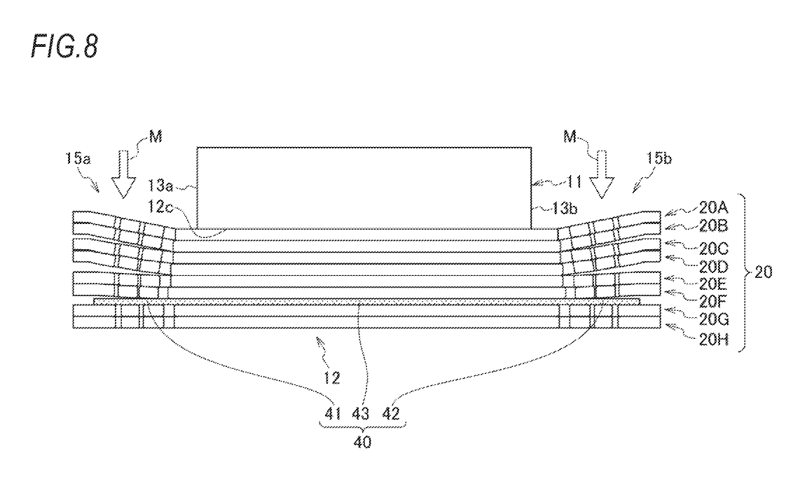

In the second embodiment illustrated in FIG. 8, eight coil segments 20A to 20H are inserted into the slot 12. Further, the heat transportation sheet 40 is arranged between a coil segment 20F arranged at the sixth position and a coil segment 20G arranged at the seventh position when counting from the radial outside of the stator core 11.

As described above, even in a case where three or more coil segments 20 are inserted into the slot 12, the inner section of the slot 12 can be cooled efficiently when the heat transportation sheet 40 is arranged between the coil segments (between the coil segments 20F and 20G in this embodiment) where heat is most likely to accumulate.

### Third Embodiment

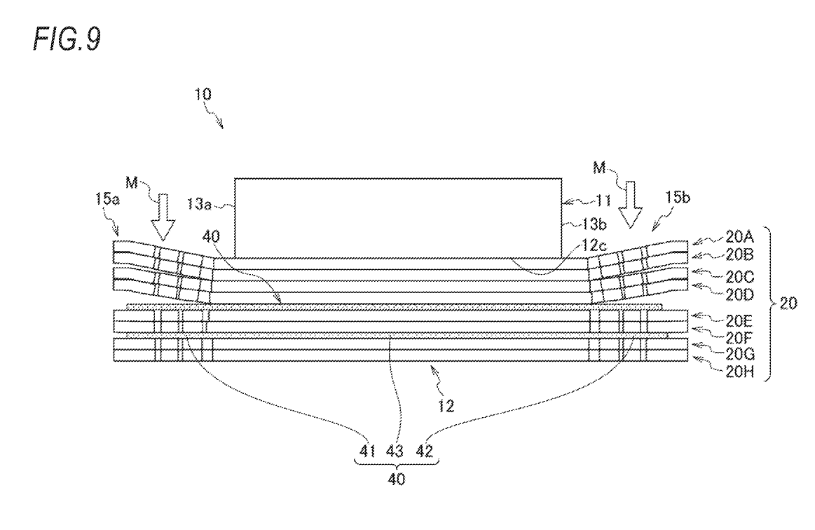

Next, a stator for a rotary electric machine 10 of a third embodiment of the present disclosure will be described. In the third embodiment illustrated in FIG. 9, the heat transportation sheet 40 is arranged also between a coil segment 20D arranged at the fourth position and a coil segment 20E arranged at the fifth position when counting from the radial outside of the stator core 11. Other configurations are similar to those of the second embodiment.

In this way, the number of the heat transportation sheets 40 arranged in each of the slots 12 is not limited to one. The inner section of the slot 12 can be cooled more efficiently compared to the second embodiment when the heat transportation sheets 40 are respectively arranged between the coil segments (between the coil segments 20F and 20G and between the coil segments 20D and 20E in this embodiment) where heat is likely to accumulate. Incidentally, the number of the heat transportation sheets 40 is not limited to two. For example, the heat transportation sheets 40 may be arranged between all adjacent coil segments of the coil segments 20A to 20H.

### Fourth Embodiment

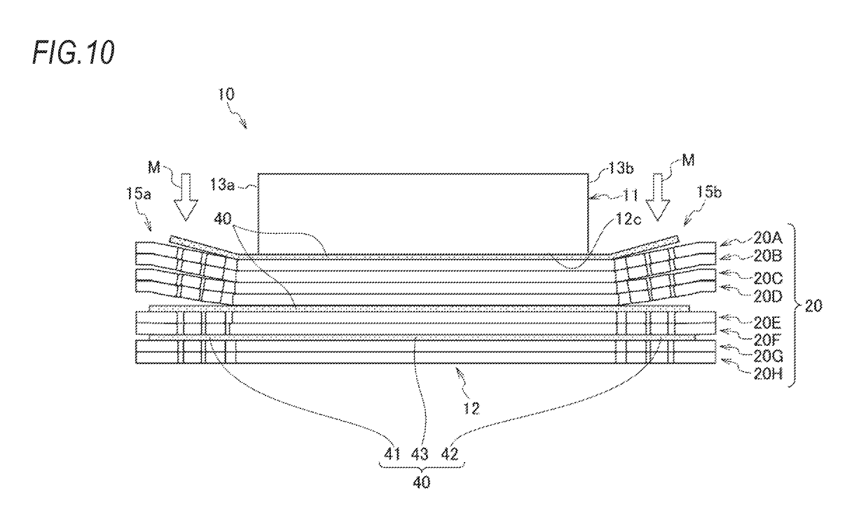

Next, a fourth embodiment of the present disclosure will be described. In a stator for a rotary electric machine 10 of the fourth embodiment illustrated in FIG. 10, the heat transportation sheet 40 is arranged also between the bottom surface 12c of the slot 12 and the coil segment 20A. Other configurations are similar to those of the third embodiment.

In this way, when the heat transportation sheet 40 is arranged also between the bottom surface 12c of the slot 12 and the coil segment 20 on the outmost diameter side, the heat transportation sheet 40 can draw heat from the bottom surface 12c of the slot 12 and the coil segment 20A. Thus, the inner section of the slot 12 can be cooled more efficiently.

Incidentally, the above-described embodiment may be modified or improved appropriately. For example, the heat transportation sheet 40 includes the refrigerant receiving parts 41 and 42 at both ends, but at least one of the refrigerant receiving parts 41 and 42 may be omitted.

At least the following items are described in this specification. Incidentally, the parentheses indicate the corresponding components or the like in the embodiment, but are not limited thereto.

(1) A stator for a rotary electric machine (stator 10) including:

a stator core (stator core 11) in which a plurality of slots (slot 12) are formed; and

a coil (coil 15) including a plurality of coil segments (coil segment 20) inserted into each of the plurality of slots, in which

at least a first coil segment (first coil segment 20A) and a second coil segment (second coil segment 20B) are arranged in each of the plurality of slots so as to be overlapped in a radial direction,

a heat transportation sheet (heat transportation sheet 40) is arranged on overlapping surfaces (overlapping surfaces 21a and 31a) of the first coil segment and the second coil segment, and

the heat transportation sheet at least includes refrigerant receiving parts (refrigerant receiving parts 41 and 42) which project from one axial end surfaces (end surfaces 13a and 13b) of the stator core and a heat exchange part (heat exchange part 43) which is positioned in the slot and exchanges heat with the first coil segment and the second coil segment at the overlapping surfaces.

According to (1), the heat transportation sheet is arranged on the overlapping surfaces of the first coil segment and the second coil segment. Thus, the refrigerant supplied to the coil end is guided to the heat exchange part through the refrigerant receiving parts. Further, heat is drawn from the first coil segment and the second coil segment at the heat exchange part, thereby cooling the inner section of the slot which has been difficult to cool so far. In addition, the refrigerant is evaporated depending on a heat quantity, and thus a conductor inside the slot can be cooled more effectively using vaporization heat.

(2) The stator for the rotary electric machine according to (1), in which a refrigerant may be movable in the heat transportation sheet by a capillary action.

According to (2), the refrigerant can be supplied from the refrigerant receiving parts to the heat exchange part by the capillary action.

(3) The stator for the rotary electric machine according to (2), in which

the heat transportation sheet may have a mesh shape.

According to (3), the heat transportation sheet in which the capillary action occurs is formed with a simple configuration.

(4) The stator for the rotary electric machine according to any one of (1) to (3), in which

an opening part (opening part 12a) of each slot may be provided in an inner circumferential surface of the stator core,

the plurality of coil segments may be inserted from each of the opening parts of the plurality of slots, and

the heat transportation sheet may be inserted from the opening part.

According to (4), the coil segment and the heat transportation sheet are inserted from the opening part formed in the inner circumferential surface of the stator core. Thus, assemblability is improved.

(5) The stator for the rotary electric machine according to any one of (1) to (4), in which

the refrigerant receiving parts may be connected in heat transportation sheets arranged in adjacent slots.

According to (5), the heat transportation sheets arranged in the adjacent slots are connected at the refrigerant receiving parts projecting from the axial one end surfaces of the stator core. Thus, the number of the heat transportation sheets can be reduced, and the man-hours for arranging the heat transportation sheet can be reduced.

(6) The stator for the rotary electric machine according to any one of (1) to (5), in which

the first coil segment may be arranged on an outmost diameter side of the slot, and

the heat transportation sheet may be arranged on facing surfaces of a bottom surface (bottom surface 12c) of the slot and the first coil segment.

According to (6), heat is drawn from the bottom surface of the slot and the first coil segment at the heat exchange part, thereby cooling the inner section of the slot which has been difficult to cool so far.

(7) The stator for the rotary electric machine according to any one of (1) to (6), in which

a plurality of heat transportation sheets may be arranged in each slot.

According to (7), a conductor inside the slot can be cooled more effectively.

What is claimed is:

1. A stator for a rotary electric machine, comprising:
a stator core in which a plurality of slots are formed; and
a coil including a plurality of coil segments inserted into each of the plurality of slots, wherein
at least a first coil segment and a second coil segment are arranged in each of the plurality of slots so as to be overlapped in a radial direction,
a heat transportation sheet is arranged on overlapping surfaces of the first coil segment and the second coil segment, and
the heat transportation sheet includes at least refrigerant receiving parts which project from one axial end surfaces of the stator core and a heat exchange part which is positioned in the slot and exchanges heat with the first coil segment and the second coil segment at the overlapping surfaces.

2. The stator for the rotary electric machine according to claim 1, wherein
a refrigerant is movable in the heat transportation sheet by a capillary action.

3. The stator for the rotary electric machine according to claim 2, wherein
the heat transportation sheet has a mesh shape.

4. The stator for the rotary electric machine according to claim 1, wherein
an opening part of each slot is provided in an inner circumferential surface of the stator core,
the plurality of coil segments are inserted from each of opening parts of the plurality of slots, and
the heat transportation sheet is inserted from the opening part.

5. The stator for the rotary electric machine according to claim 1, wherein
the refrigerant receiving parts are connected in heat transportation sheets arranged in adjacent slots.

6. The stator for the rotary electric machine according to claim 1, wherein
the first coil segment is arranged on an outmost diameter side of the slot, and
the heat transportation sheet is arranged on facing surfaces of a bottom surface of the slot and the first coil segment.

7. The stator for the rotary electric machine according to claim 1, wherein
a plurality of heat transportation sheets are arranged in each slot.
